(19) United States
(12) Patent Application Publication
(10) Pub. No.: US 2014/0204278 A1
(43) Pub. Date: Jul. 24, 2014

(54) INITIATING THE PLAYING OF MEDIA STORED ON A MEDIA SOURCE DEVICE WHILE IN POWER SAVING MODE

(71) Applicant: HEWLETT-PACKARD DEVELOPMENT COMPANY, L.P., Houston, TX (US)

(72) Inventor: Michael C. MCCULLOUGH, San Jose, CA (US)

(73) Assignee: Hewlett-Packard Development Company, L.P., Houston, TX (US)

(21) Appl. No.: 13/749,213

(22) Filed: Jan. 24, 2013

(51) Int. Cl. H04N 5/93; H04N 5/44

(52) U.S. Cl. CPC H04N 5/93; H04N 5/4403
USPC 348/734; 386/353

(57) ABSTRACT

Randomly initiating the playing of media stored on a media source device while it is in power saving mode is provided. Information is received at an electronic controller device pertaining to a user selected option to play on a media player the media stored on the media source device. The user selected option initiates randomly playing the media stored on the media source device with power saving capabilities. In response to receiving the information, the electronic controller device sends a first command to wake up the media source device from a power saving mode, sends a second command to power on audio video equipment, and sends sending a third command to power on the media player.

### BACKGROUND

With the digitization of media, such as music, photos, and videos, many people want to store their media for later access and enjoyment on a media source device, such as a computer system, a personal computer or a home server. Media source devices typically consume a large amount of power. Therefore, they are frequently provided with power saving capabilities that enable them to go into a power saving mode also known as a sleep mode.

### BRIEF DESCRIPTION OF THE DRAWINGS

The accompanying drawings, which are incorporated in and form a part of this Description of Examples, illustrate various examples of the present disclosure and, together with the description, serve to explain principles discussed below: The Figures are not drawn to scale unless specified.

FIG. 1 depicts a block diagram of a remote controller for randomly initiating the playing of media stored on a media source device while in a power saving mode, according to one embodiment.

FIG. 2 depicts a block diagram of a system for randomly initiating the playing of media stored on a media source device while in a power saving mode, according to one embodiment.

FIG. 3 depicts a flowchart of an integrated method for randomly initiating the playing of media stored on a media source device while in a power saving mode, according to one embodiment.

### DETAILED DESCRIPTION EXAMPLE

Reference will now be made in detail to various embodiments of the subject matter, examples of which are illustrated in the accompanying drawings. While various embodiments are discussed herein, it will be understood that they are not intended to be limited to these embodiments. On the contrary, the presented embodiments are intended to cover alternatives, modifications and equivalents, which may be included within the spirit and scope the various embodiments as defined by the appended claims. Furthermore, in the following Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Unless specifically stated otherwise as apparent from the following discussions, it is appreciated that throughout the description of embodiments, discussions utilizing terms such as “receiving,” “pertaining,” selecting,” “storing,” “sending,” “playing,” “controlling,” “establishing,” “communicating,” “initiating,” “displaying,” “re-charging,” “transforming data.” “modifying data to transform the state of a computer system,” or the like, refer to the actions and processes of a computer system, data storage system, storage system controller, microcontroller, processor, or similar electronic computing device or combination of such electronic computing devices. The computer system or similar electronic computing device manipulates and transforms data represented as physical (electronic) quantities within the computer system's/device's registers and memories into other data similarly represented as physical quantities within the computer system's/device's memories or registers or other such information storage, transmission, or display devices.

A media source device has to be powered on and awake in order to access media that is stored on it. A media source device may be located any where within an environment, such as a home, office or building, and a user who wants to access the media stored on the media source device may be located elsewhere within the same environment or outside of that environment. Therefore, according to one embodiment, an environment is associated with a building, is the building or is a part of the building. To enable the user to randomly access the media at any time, a media source device could be left powered on and fully operational 24 hours a day, 7 days a week. However, this is in direct conflict with energy conservation.

According to one embodiment, a fully integrated method and system are provided for randomly initiating the playing media that is stored on a media source device while it is in a power saving mode. Examples of media are music, photos, and videos. Media can be any type recorded media that can be seen or heard or a combination thereof. The method and system are “fully integrated” because, according to one embodiment, a single electronic device, such as a remote controller, can cause all of the electronic devices used for playing the media to become fully operational. Further, according to one embodiment, a single user selection, such as pressing a button or selecting an option from a menu, can be used for making all of the electronic devices used for playing the media to become fully operational. Fully operational refers an electronic device being capable of playing the media without further action on the part of the user. For example, an electronic device with power saving capabilities may be fully operational when it is powered on and awake. An electronic device that does not have power saving capabilities may be fully operation when it is powered on.

According to one embodiment, the method and system provides for “randomly initiating the playing of media” because, for example, a user at any time can cause one or more of the electronic device for playing the media to become fully operational. The user is enabled to randomly initiate the playing media because, according to one embodiment, the user can cause the media to be played at any time in response to the user selecting an operation to play the media. More specifically, a media source device can be woken up, the audio video equipment can be powered on, and the media player can be powered on by pressing a button or selecting an option associated with a remote controller at any time.

Therefore, various embodiments provide for playing media stored on a sleeping media source device without the user having to physically move to where the media source device is located and manually waking it up from a sleep mode (also known as a “power saving mode”). Further, various embodiments provide for playing media stored on a sleeping media source device without using or requiring timers that wake the media source device up at previously specified times. The use of a timer to wake a media source device up at a previous specified time is not random, according to one embodiment. Further still, various embodiments provide for using the power saving capabilities of a media source device while at the same time having the capability of randomly waking the media source device using a single electronic device that is remotely located with respect to the media source device at any time that the user desires without the user pre-specifying a time.

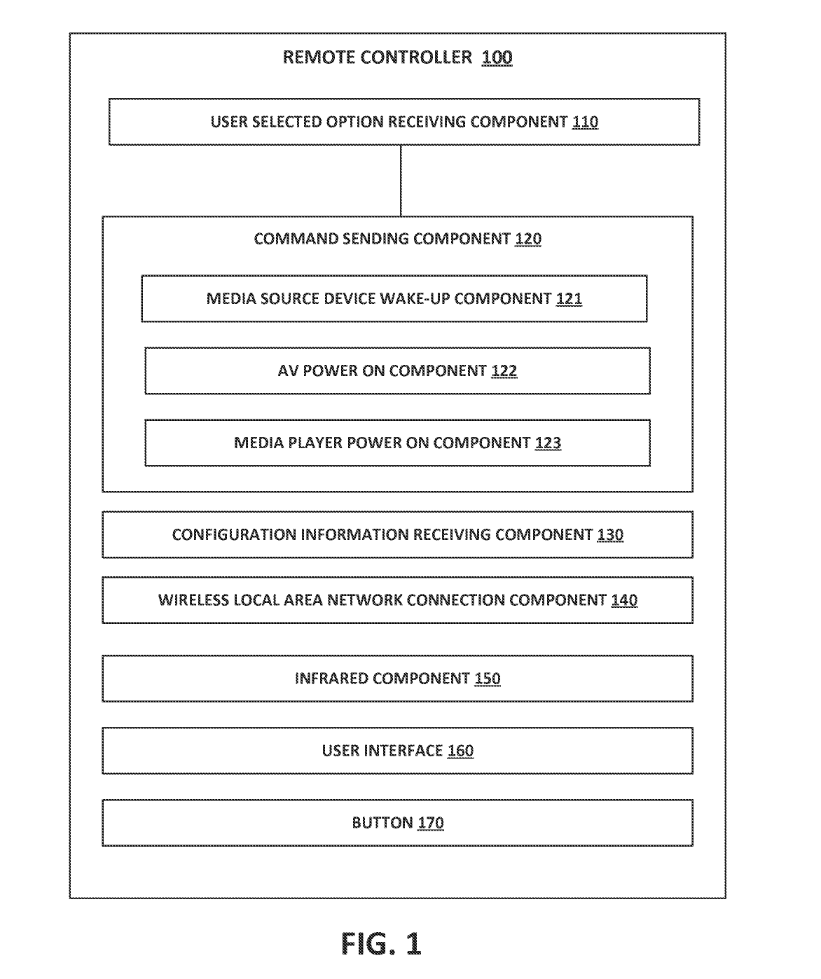

FIG. 1 depicts a block diagram of a remote controller 100 for randomly initiating the playing of media stored on a media source device while in a power saving mode, according to one embodiment. The blocks that represent features in FIG. 1 can be arranged differently than as illustrated, and can implement additional or fewer features than what are described herein. Further, the features represented by the blocks in FIG. 1 can be combined in various ways. The remote controller 100 can be implemented using hardware, hardware and software, hardware and firmware, or a combination thereof. The remote controller 100 may include a computer processor for executing any software that may be stored in memory of the remote controller 100.

The electronic devices, such as media source players, computer devices, audio video equipment, media players, stand alone media players, among others, that the remote controller 100 communicates with may use wireless, wired or a combination thereof communication technologies. According to one embodiment, the remote controller 100 includes a wireless local area network connection component 140 for communicating wirelessly with a local area network. The remote controller 100 can use the wireless local area network connection component 140 to communicate wirelessly, for example, with a router associated with the local area network. The communications between the router and the electronic devices may be wired or wireless or a combination thereof. According to one embodiment, the electronic devices that the remote controller 100 communicates with are legacy electronic devices and, therefore, do not require additional infrared (IR) or radio frequency (RF) capabilities beyond what they already have.

According to one embodiment, the remote controller 100 is an electronic device that includes hardware. The remote controller 100 may be a remote controller 100 for a media player. The remote controller 100 may be a universal remote controller that can be used with most types of media players. The remote controller 100 may be a part of another electronic device such as a cell phone or a tablet. The remote controller 100 may be battery operated. The remote controller 100 can be a mobile device. The remote controller 100 can be any electronic device that is capable of implementing a user selected option receiving component 110 and a command sending component 120.

The remote controller 100 includes a user selected option receiving component 120 and a command sending component 120. The user selected option receiving component 120 is capable of receiving a user selected option to play on a media player the media stored on the media source device. The user selected option initiates randomly playing the media on the media source device that has power saving capabilities.

The command sending component 120 is capable of sending commands in response to receiving the user selected option. Examples of sent commands are a first command (also referred to herein as “wake up command”) to wake up the media source device from a power saving mode, a second command to power on audio video equipment, and a third command to power on the media player. According to one embodiment, the first command for waking up the media source device is implemented using a Wake-On-Lan (WOL) with Magic Packet (also referred to herein as a “magic packet”). According to one embodiment, magic packets are unique for each type of electronic device that they are associated with. The user selected option receiving component 120 and the command sending component 120 are implemented at least in part in firmware of the remote controller 100, according to one embodiment. The command sending component 120 may include a media source device wake-up component 121 for sending the first command, an audio video power on component 122 for sending the second command, and a media player power on component 123 for sending the third command.

The remote controller 100 may also include one or more of an infrared component 150, configuration information receiving component 130, a user interface 160 and one or more buttons 170. The configuration information receiving component 130 can receive a media source device's configuration information, such as an internet protocol address of the media source device, a media access control address associated with the media source device, name of the media source device, or magic packet of the media source device, or a combination thereof. The configuration information receiving component 130 can receive configuration information for a plurality of media source devices. The configuration information for the one or more media source devices can be stored on the remote controller 100.

The user interface 160 can be used to display the stored names of the media source devices, for example, in response to a user requesting a list of the media source devices' names. A user can select an option to play media stored on a particular media source device, for example, by selecting a displayed media source device's name or pressing a button 170 associated with that particular media source device. Different buttons 170 of the remote controller 100 can be used to select different media source devices.

The local area network may be a home network. The local area network may be a wireless network, such as a WiFi network, and the wireless local area network connection component 140 may provide wireless capabilities for the remote controller 100 to connect to the wireless network. The local area network may be wired, wireless or a combination thereof. The infrared component 150 can be used for sending a command to power on an electronic device that has infrared capabilities, such as audio video equipment or a media player or any other type of electronic device.

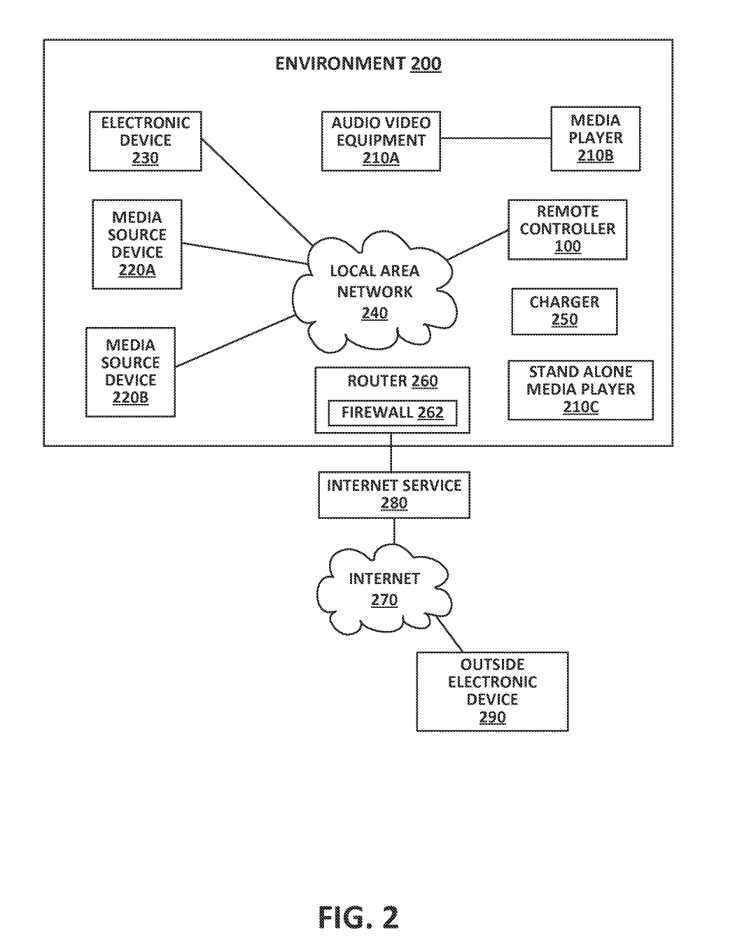

FIG. 2 depicts a block diagram of a system for randomly initiating the playing of media stored on a media source device while in a power saving mode, according to one embodiment. The blocks that represent features in FIG. 2 can be arranged differently than as illustrated, and can implement additional or fewer features than what are described herein. Further, the features represented by the blocks in FIG. 2 can be combined in various ways. The system depicted in FIG. 2 can be implemented using hardware, hardware and software, hardware and firmware, or a combination thereof.

The system depicted in FIG. 2 includes a local area network 240, which may be wired or wireless or a combination thereof, a remote controller 100, media source devices 220A, 220B, electronic device 230, audio video equipment 210A, a media player 210B, stand alone media player 210C, a router 260, an internet 270, an internet service 280, an outside electronic device 290 and a charger 250. Although FIG. 2 depicts two media source devices 220a, 220b, various embodiments are well suited to more or less media source devices than what are depicted in FIG. 2. According to one embodiment, the media player 210B is connected, for example, using wired communications with the audio video equipment 210A. According to one embodiment, the stand alone media player 210C includes its own audio equipment or audio video equipment. The local area network 240, the remote controller 100, the media source devices 220A, 220B, the electronic device 230, the audio video equipment 210A, the media player 210B, the stand alone media player 210C, and the router 260 are located inside of an environment 200, such as a room, a home, an office, or a building. The router 260, as depicted, includes a firewall 262. The internet 270, the internet service 280 and the outside electronic device 290 are located outside of the environment 200.

According to one embodiment, the media source devices 220A, 220B, the electronic device 230 and the remote controller 100 are connected to the same network, such as a local area network 240. The media source devices 220A, 220B and the electronic device 230 may use wired or wireless communications. According to one embodiment, the local area network 240 and the Internet 270 provide two parts of a single network where the router 260 provides a bridge between the two parts of the network.

A media source device 220A, 220B can be any type of electronic device with power saving capabilities that is capable of storing media and providing that media to a media player 210B, 210C. For example, a media source device 220A, 220B may be a personal computer or a home server. The media source device 220A, 220B may be implemented with either Universal Plug and Play (UPnP) or Digital Living Network Alliance (DNLA), or a combination thereof. The media player 210B, 210C may be any type of electronic device that is capable of playing media, such as a television, a set top box, a stereo, a computer system, or a ROKU® device.

Configuration information, such as an internet protocol address, media access control address, name, or magic packet, or a combination thereof, can be obtained for each of the media source devices 220A, 220B, and received by the remote controller 100. For example, a user could plug a universal serial bus (USB) stick into each of the media source devices 220A, 220B to obtain their respective configuration information and transfer the configuration information to the remote controller 100 by plugging the USB stick into the remote controller 100. The USB stick may include a utility, which may be software, that enables obtaining the configuration information from the media source devices 220A, 220B or transferring the configuration information from the USB stick to the remote controller 100, or a combination thereof. In another example, configuration information could be transferred over the local area network 240 from the media source devices 220A, 220B to the remote controller 100. The received configuration information can be stored, for example, in a table or a database on the remote controller 100.

Various embodiments are also well suited for waking up an electronic device 230 that is not a source of media from a sleep mode. For example, configuration information could be obtained from the electronic device 230 and transferred to the remote controller 100 as discussed herein and the remote controller 100 could use that configuration information to wake up the electronic device 230 that is used for a different purpose than playing media. Various embodiments are well suited for randomly initiating the performance of an action on the part of the electronic device 230 in an integrated fashion using a single user selected option, such as pressing a button or selecting an option from a menu, as discussed herein. The electronic device 230 is well suited for other various embodiments described herein.

There are various ways that a user could cause media stored on a media source device 220A, 220B to be played on a media player 210B, 210C. For example, the user could cause a user interface to display a name of each of the one or more media source devices 220A, 220B and select the desired media source device 220A, 220B's name from the one or more displayed names. In another example, the user could press a button that is configured to select a particular media source device 220A, 220B. When the user selects a media source device 220A, 220B either by pressing a button or by selecting its displayed name, the remote controller 100 can send commands to the audio video equipment 210A and a media player 210B, 210C to power them on and send a wake up command, such as a WOL command, to the selected media source device 220A, 220B to wake it up.

According to one embodiment, the remote controller 100 can serve as an intermediate device between an outside electronic device 290 that is outside of the environment and the media source device 220A, 220B that is inside of the environment. For example, the user may interact with the outside electronic device 290 to cause the remote controller 100 to wake up the media source device 220A, 220B. More specifically, the remote controller 100, according to various embodiments, can contain detailed configuration information, as discussed herein, that the remote controller 100 uses wake up a media source device 220A, 220B. Thus, the outside electronic device 290 can wake up a media source device 220A, 220B by interacting with the remote controller 100 in a simplified manner and without knowledge of the configuration information of the media source device 220A, 220B. Once the media source device 220A, 220B has been awakened, then it can be used. More specifically, a media source device 220A, 220B can be used to provide one or more media files to the outside electronic device 290 or perform other functions. Similar the outside electronic device 290 can be used to wake up the electronic device 230 and then the electronic device 230 can be used to provide files to the outside electronic device 290 or to perform other functions.

Various methods of enabling communications through the firewall 262 can be used. For example, the firewall 262 in the router 260 that provides security for electronic devices connected with the local area network 240 can be configured to allow communications to pass through a port of the router 260 to the remote controller 100. In another example, an authorized internet service 280 can be used for establishing communications between the remote controller 100 and the outside electronic device 290. The user could cause one or more names of the media source devices 220A, 220B′ to be displayed on their outside electronic device 290 and select the name of the media source device 220A, 220B that they want to wake up.

According to one embodiment, the remote controller 100 is battery operated. The remote controller 100 can be placed in a charger 250 to recharge the remote controller 100's batteries. The charger 250 could also serve as a dock, which may enable a wired network connection to the local area network 240 while the remote controller 100 is located in the charger 250. According to one embodiment, the remote controller 100 is a mobile device that can be moved from location to location. The remote controller 100 can remain functional and able to communicate over the network while on the charger, and or while operating from batteries.

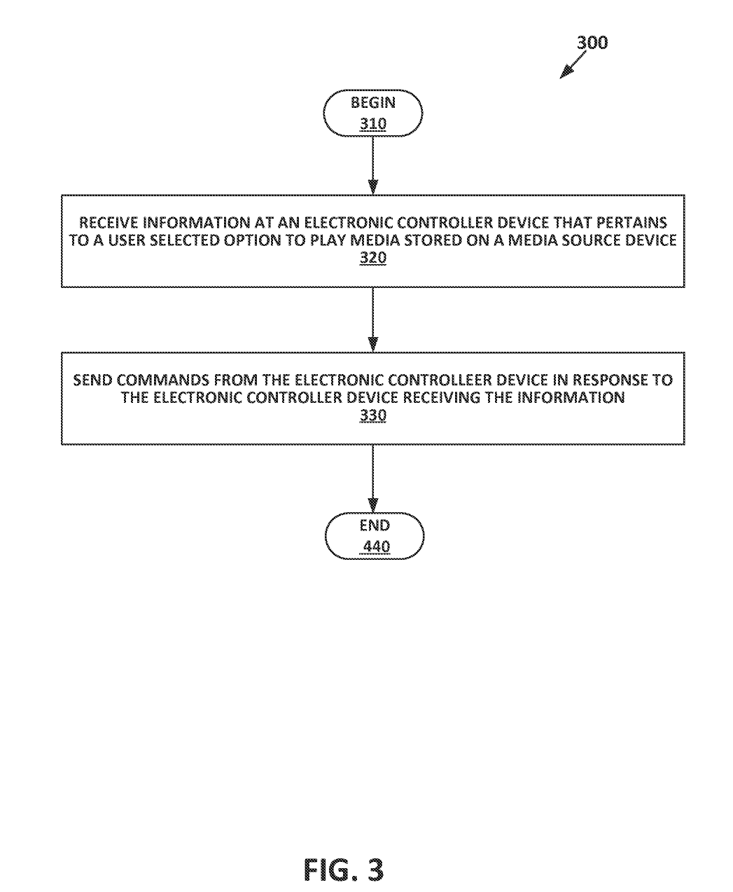

FIG. 3 depicts a flowchart 300 of an integrated method for randomly initiating the playing of media stored on a media source device while in a power saving mode, according to one embodiment.

Although specific operations are disclosed in flowchart 300, such operations are exemplary. That is, embodiments of the present disclosure are well suited to performing various other operations or variations of the operations recited in flowchart 300. It is appreciated that the operations in flowchart 300 may be performed in an order different than presented, and that not all of the operations in flowchart 300 may be performed.

The illustration of flowchart 300 shall refer to FIGS. 1 and 2. For the purpose of illustration, assume that the remote controller 100 has already been configured with configuration information, such as the internet protocol (IP) addresses, the media access control (MAC) addresses, the names, and the magic packets, of the media source devices 220A, 220B, as described herein. For the purposes of illustration, assume that the user will select an option to play media source device 220A.

At 310, the method begins.

At 320, information is received at an electronic controller device 100 that pertains to a user selected option to play on the media player 210b the media stored on the media source device 220A. For example, the user may press a button 170 that selects media source device 220A or selects the name of media source device 220A from one or more displayed names for the media source devices 220A, 220B.

The user selected option can initiate randomly playing the media on the media source device 220A while in a power saving mode. For example, the user can select media source device 220A or any other media source device 220B that the electronic controller device 100 has stored configuration information for at any time 24 hours a day, 7 days a week without the electronic controller device 100 having any advance warning as to when the user will select the media source device 220A, 220B. An example of advance warning is pre-specified times for waking up a media source device 220A, 220B.

At 330, in response to receiving the information, the electronic controller device 100 sends commands. For example, the first command sent can be for waking up the selected media source device 220A from a power saving mode. According to one embodiment, the first command is a magic packet as described herein. The second command sent can be for powering audio video equipment 210A on. The third command sent can be for powering a media player 210B on.

At 340, the method ends.

Since in this illustration, the user selected electronic device 220A to play the media, after execution of the method for flowchart 300, the electronic controller device 100, which is a single controller device, has caused all electronic devices 220A, 210A, 210B that are used as a part of playing the media stored on the selected electronic device 220A to become fully operational by sending commands from the electronic controller device 100 to all of the electronic devices 220A, 210A, 210B used as a part of playing the media. According to one embodiment, at least one of the commands is a wake up command, such as a WOL command, that is sent to the selected electronic device 220A that is in a power saving mode.

The above illustration of flowchart 300 is only provided by way of example and not by way of limitation.

Any one or more of the embodiments described herein can be implemented using non-transitory computer readable storage medium and computer-executable instructions which reside, for example, in computer-readable storage medium of a computer system or like device. The non-transitory computer readable storage medium can be any kind of memory that instructions can be stored on. Examples of the non-transitory computer readable storage medium include but are not limited to a disk, a compact disk (CD), a digital versatile device (DVD), read only memory (ROM), flash, and so on. As described above, certain processes and operations of various embodiments of the present disclosure are realized, in one embodiment, as a series of instructions (e.g., software program) that reside within non-transitory computer readable storage memory of a computer system and are executed by the computer processor of the computer system. When executed, the instructions cause the computer system to implement the functionality of various embodiments of the present disclosure. According to one embodiment, the non-transitory computer readable storage medium is tangible.

According to one embodiment, a non-transitory computer readable storage medium comprising an integrated method for randomly initiating the playing media stored on an electronic device 220A, 220B while in a power saving mode. The method of the non-transitory computer readable storage medium comprising receiving, at a single controller device 100, information pertaining to a user selected option to play the media stored on the electronic device 220A, 220B on a media player 210B where the user selected option initiates randomly playing the media on the electronic device 220A or 220B with power saving capabilities, and in response to receiving the information, using the single controller device 100 to cause all of one or more electronic devices 210A, 210B, 220A, or 220B used as a part of playing the media to become fully operational by sending commands from the single controller device 100 to all of the one or more electronic devices 210A, 210B, 220A, or 220B, where at least one of the commands is to wake up one of the electronic devices 210A, 210B, 220A, or 220B from a power saving mode.

According to one embodiment, the sending of the commands associated with the non-transitory computer readable storage medium further comprises sending a first command to wake up the one of the electronic devices 220A, 220B from the power saving mode, sending a second command to power on audio video equipment 210A, and sending a third command to power on the media player 210B.

According to one embodiment, the method associated with the non-transitory computer readable storage medium further comprises receiving configuration information for the electronic device 220A or 220B where the media is stored, wherein the configuration information includes an internet protocol address, media access control (MAC) address, a name, and a magic packet for the electronic device 220A or 220B where the media is stored, and storing the configuration information at the single controller device 100.

According to one embodiment, the sending of the first command associated with the non-transitory computer readable storage medium further comprises sending a magic packet to the electronic device 220A or 220B where the media is stored.

Various embodiments provide for backward compatibility with legacy electronic devices, such as media source players, legacy computer devices, legacy audio video equipment, legacy media players. For example, various embodiments can be used with any audio video equipment or media players that can be powered on, for example, using infrared technology or an equivalent. Various embodiments can be used for any media source players that support a local area network (LAN), which may use wired or wireless communications, and a wake up command, such as a magic packet or an equivalent. However, various embodiments are not limited to infrared technology, LAN technology, or magic packet. Various embodiments are well suited to other types of communications technologies and other types of commands.

Various embodiments do not use or do not require timers to wake up any of the electronic devices. Various embodiments do not use or do not require an electronic device to automatically wake up upon connection, for example, with a network. For example, the establishment of a connection between the remote controller and a media source device, according to various embodiments, is not what causes the media source device to wake up, according to one embodiment. More specifically, according to one embodiment, both the media source device and the remote controller may already be connected with a wireless local area network when the user selects the option to play media from the media source device, for example, by pressing a button or selecting the option from a menu. Various embodiments do not use or do not require waking up multiple devices in order to play media. For example, various embodiments are well suited to play media by waking up a single media source device. Various embodiments do not require any of the media source devices to be connected to more than one network. Various embodiments do not need or do not require a computer keyboard. For example, various embodiments do not use or require a keyboard that is separate from any of one or more media source devices and connected to any of the one or more media source devices using either a wirelessly or wired connection. In contrast, various embodiments are well suited to pressing a button that is a part of a controller device or selecting an option, such as a displayed media source device's name.

Example embodiments of the subject matter are thus described. Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

Various embodiments have been described in various combinations and illustrations. However, any two or more embodiments or features may be combined. Further, any embodiment or feature may be used separately from any other embodiment or feature. Phrases, such as “an embodiment,” “one embodiment,” among others, used herein, are not necessarily referring to the same embodiment. Features, structures, or characteristics of any embodiment may be combined in any suitable manner with one or more other features, structures, or characteristics.

What is claimed is:

1. An integrated method for randomly initiating the playing of media stored on a media source device while in power saving mode, wherein the method comprises:
receiving, at an electronic controller device, information pertaining to a user selected option to play on a media player the media stored on the media source device, wherein the user selected option initiates randomly playing the media stored on the media source device with power saving capabilities; and
in response to receiving the information, the electronic controller device,
sending a first command to wake up the media source device from the power saving mode;
sending a second command to power on audio video equipment; and
sending a third command to power on the media player.

2. The method as recited by claim 1, wherein the method further comprises:
receiving configuration information for the media source device, wherein the configuration information includes an internet protocol address of the media source device, a media access control address associated with the media source device, a name of the media source device, and a magic packet for the media source device; and
storing the configuration information at the controller.

3. The method as recited by claim 1, wherein the sending of the first command further comprises:
sending a magic packet to the media source device.

4. The method as recited by claim 1, wherein the method further comprises:
receiving, at the electronic controller device, information pertaining to the user selected option in response to the user performing an activity selected from a group consisting of pressing a button on the electronic controller device and selecting a displayed name of the media source device.

5. The method as recited by claim 1, wherein the electronic controller device, the media source device, the audio video equipment and the media player are inside of an environment associated with a building.

6. The method as recited by claim 5, wherein the method further comprises:
receiving the information pertaining to the user selected option in response to the user performing an activity on an outside electronic device that is outside of the environment, wherein the electronic controller device is an intermediate device between the outside electronic device and the media source device.

7. The method as recited by claim 6, wherein method further comprises:
implementing communication between the outside electronic device and the electronic controller device, wherein the implementing for the communication is selected from configuring a firewall for allowing the communication to pass through a port and using an authorized internet service for establishing the communication between the controller and the outside electronic device.

8. An integrated remote controller for randomly initiating the playing of media stored on a media source device while in power saving mode, wherein the remote controller comprising:
firmware;
a user selected option receiving component for receiving a user selected option to play on a media player the media stored on the media source device, wherein the user selected option initiates randomly playing the media stored on the media source device with power saving capabilities; and
a command sending component for sending commands in response to receiving the user selected option, wherein the sent commands include a first command to wake up the media source device from the power saving mode, a second command to power on audio video equipment, and a third command to power on the media player,
wherein the user selected option receiving component and the command sending component are implemented at least in part in the firmware of the remote controller.

9. The remote controller of claim 8, wherein the remote controller further comprises:
an infrared component for sending a command to an electronic device with infrared capabilities.

10. The remote controller of claim 8, wherein the remote controller further comprises:
a wireless local area network connection component for sending a command to an electronic device that is connected to a local area network.

11. The remote controller of claim 10, wherein the local area network is a home network.

12. The remote controller of claim 8, wherein the remote controller further comprises:
a configuration information receiving component for receiving configuration information for the media source device, wherein the configuration information includes one or more of an internet protocol address of the media source device, a media access control address associated with the media source device, a name of the media source device, and a magic packet for the media source device.

13. The remote controller of claim 8, wherein the remote controller further comprises:
a user interface for displaying a name of the media source device and for receiving the user selected option to play the media in response to the user selecting the name.

14. The remote controller of claim 8, wherein the remote controller further comprises:
a button that when pressed by the user generates the user selected option to play the media.

15. The remote controller of claim 8, wherein the remote controller further comprises one or more batteries.

16. The remote controller of claim 15, wherein the remote controller is configured for recharging the one or more batteries by placing the remote controller in a charger.

17. A non-transitory computer readable storage medium comprising instructions for randomly initiating the playing of media stored on an electronic device while in power saving mode, wherein the instructions when executed cause a single controller device to:
receive, at the single controller device, information pertaining to a user selected option to play on a media player the media stored on the electronic device, wherein the user selected option initiates randomly playing the media stored on the electronic device with power saving capabilities; and
in response to receiving the information, cause all of one or more electronic devices used as a part of playing the media to become fully operational by sending commands from the single controller device to all of the one or more electronic devices used as a part of playing the media, wherein at least one of the commands is to wake up one of the electronic devices from the power saving mode.

18. The non-transitory computer readable storage medium as recited by claim 17, wherein the instructions further cause the single controller to:
send a first command to wake up the one of the electronic devices from the power saving mode;
send a second command to power on audio video equipment; and
send a third command to power on the media player.

19. The non-transitory computer readable storage medium as recited by claim 18, wherein the instructions further cause the single controller to:
send a magic packet to the one of the electronic devices in the power saving mode.

20. The non-transitory computer readable storage medium as recited by claim 17, wherein the instructions further cause the single controller to:
receive configuration information for the electronic device that stores the media, wherein the configuration information includes an internet protocol address, a media access control address, a name, and a magic packet for the electronic device that stores the media; and
store the configuration information at the single controller device.
